(19) United States
(12) Patent Application Publication
(10) Pub. No.: US 2006/0100866 A1
(43) Pub. Date: May 11, 2006

(54) Influencing automatic speech recognition signal-to-noise levels

(75) Inventors: Neal J. Alewine, Lake Worth, FL (US); John W. Eckhart, Boca Raton, FL (US); Harvey M. Ruback, Loxahatchee, FL (US); Josef Vopieka, Praha (CZ)

Correspondence Address: AKERMAN SENTERFITT, P. O. BOX 3188, WEST PALM BEACH, FL, 33402-3188, US

(73) Assignee: INTERNATIONAL BUSINESS MACHINES CORPORATION, Armonk, NY (US)

(21) Appl. No.: 10/975,569

(22) Filed: Oct. 28, 2004

(51) Int. Cl. G10L 21/02

(52) U.S. Cl. 704/226

(57) ABSTRACT

A system for influencing a signal-to-noise ratio (SNR) associated with a signal input to an automatic speech recognition device is provided. The system includes a normalized energy module that determines a normalized energy measurement based upon a spectrum of frequency-domain complex coefficients, the coefficients generated by the automatic speech recognition device. The system also includes an SNR module that generates an SNR measurement. The SNR measurement can be based upon a comparison of speech and non-speech portions of the signal input to the automatic speech recognition device. The system further includes a cue module that provides a cue to a user of the automatic speech recognition device, the cue being based upon the SNR measurement.

### BACKGROUND

1. Field of the Invention

The present invention is related to the field of signal processing, and, more particularly, to the field of signal processing in connection with automatic speech recognition.

2. Description of the Related Art

Speech recognition engines, even those that otherwise perform well in most circumstances, can be adversely affected by ambient conditions. A noisy environment can significantly degrade the performance of a speech recognition engine. A contributing factor to performance degradation is a reduction in the signal-to-noise ratio (SNR). The SNR is an oft-used figure of merit indicating a system's performance. Noise is usually present to a varying degree in all electrical systems due to internal factors such as the thermal-energy-induced random motion of charge carriers as well as noise from external sources. Noise can be particularly harmful to a communication system. With respect to automatic speech recognition engines, noise comes in the form of collateral sounds such as a car A/C fan, background babble, road noise, and other acoustic energy not part of the speech being recognized. A low SNR can adversely affect the various processes of speech recognition, including feature extraction and silence detection.

A related problem in the context of speech recognition stems from the variation of speech patterns among individual users of a speech recognition engine, in particular, variations in speech energy (volume) among speakers. Speech recognition engine performance is likely to be poorer the more softly a particular user speaks. Again, the problem is that the SNR is likely to be lower for soft speech, with the result that the accuracy of the speech recognition is likely to be degraded accordingly.

Conventional approaches to these problems include providing a visual meter during speech recognition to indicate the volume at which a user is speaking. The principle is essentially the same as that of one party to a telephone conversation telling the other party to speak up when one is unable to hear the other. The problem with such an approach, however, is that the visual volume meter also rises in response to background noise. The use of a simple visual volume meter can obscure the nature of a speech recognition performance problem and, thus, the user is less likely to take appropriate action to ameliorate the problem by speaking more loudly and/or relocating to a less noisy environment.

A related problem that appears unaddressed by most conventional volume-based approaches is how to determine a speech recognition SNR without unduly impacting the resources of the speech recognition device. This related problem arises because the calculations involved in determining the SNR are resource-intensive and can impose considerable computational overhead on the speech recognition device.

### SUMMARY OF THE INVENTION

The present invention provides a system, apparatus, and related methods for influencing an SNR measurement associated with speech input into a speech recognition device. The SNR measurement, according to one embodiment of the invention, can be based upon a comparison of speech content of an input signal into the speech recognition device to non-speech content of the input signal. The system, apparatus, and methods can efficiently determine the SNR associated with the speech input and can use the SNR as a basis for a cue that can be provided to the user in order to influence the SNR. The cue can indicate to a user that the user should alter his or her speech and/or change location as necessary to attain and maintain an acceptable SNR.

A system for influencing a signal-to-noise ratio (SNR) associated with a signal input to an automatic speech recognition device can include an SNR module for determining an SNR measurement associated with a user's signal input to the speech recognition device. The system further can include a cue module for providing a cue to the user based upon the SNR measurement.

According to one embodiment, the system can include a normalized energy module. The normalized energy module can determine a normalized energy measurement that is based upon a power spectrum of frequency-domain complex coefficients generated by the automatic speech recognition device. The system also can include an SNR module that generates an SNR measurement based upon the normalized energy measurement. According to another embodiment, the SNR measurement generated by the SNR module can be based upon a comparison of speech content of the signal input to non-speech content of the signal input.

According to yet another embodiment, the cue module can be a visual cue model that provides a visual cue to a user. The visual cue can be based upon the SNR measurement. If the SNR measurement is not with an acceptable range, the visual cue can indicate this to the user. The user can thus undertake an appropriate response to bring the SNR into the acceptable region. For example, the user can speak more loudly and/or relocate to a less noisy environment.

A method of influencing a signal-to-noise ratio (SNR) associated with a signal input to an automatic speech recognition device can include generating an SNR measurement associated with a signal input supplied by a user to the automatic speech recognition device. The method further can include providing a cue to the user based upon the SNR measurement. The method can include generating an SNR measurement, in accordance with another embodiment, that is based upon a comparison of speech content of the signal input to non-speech content of the signal input.

In still another embodiment, a method of influencing a signal-to-noise ratio (SNR) associated with a signal input to an automatic speech recognition device can include the step of determining a normalized energy measurement based upon a spectrum of frequency-domain complex coefficients generated by the automatic speech recognition device. Additionally, the method can include generating an SNR measurement based upon the normalized energy measurement. The method can further include providing a visual cue to a user of the automatic speech recognition, the visual cue being based upon the SNR measurement.

An apparatus, according to yet another embodiment, can comprise a computer-readable storage medium containing computer instructions for influencing a signal-to-noise ratio (SNR) associated with a signal input to an automatic speech recognition device. The computer instructions can include instructions for generating an SNR measurement associated with the signal input, and for providing a cue to a user of the automatic speech recognition, the cue being based upon the SNR measurement. According to still another embodiment, the SNR measurement generated per the computer instructions can be based upon a comparison of speech content of the signal input to non-speech content of the signal input.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of an apparatus including an automatic speech recognition device and a system for influencing a signal-to-noise ratio (SNR) associated with a signal input to the speech recognition device according to one embodiment of the present invention.

FIG. 2 is a schematic diagram of a system for influencing a signal-to-noise ratio (SNR) associated with a signal input to the speech recognition device according to another embodiment of the present invention.

FIG. 3 is a flowchart illustrating the steps of a method for influencing a signal-to-noise ratio (SNR) associated with a signal input to a speech recognition device according still another embodiment of the present invention.

FIG. 4 is a flowchart illustrating the steps of a method for influencing a signal-to-noise ratio (SNR) associated with a signal input to a speech recognition device according yet another embodiment of the present invention.

FIG. 5 is a flowchart illustrating the steps of a method for influencing a signal-to-noise ratio (SNR) associated with a signal input to a speech recognition device according still another embodiment of the present invention.

### DETAILED DESCRIPTION OF THE INVENTION

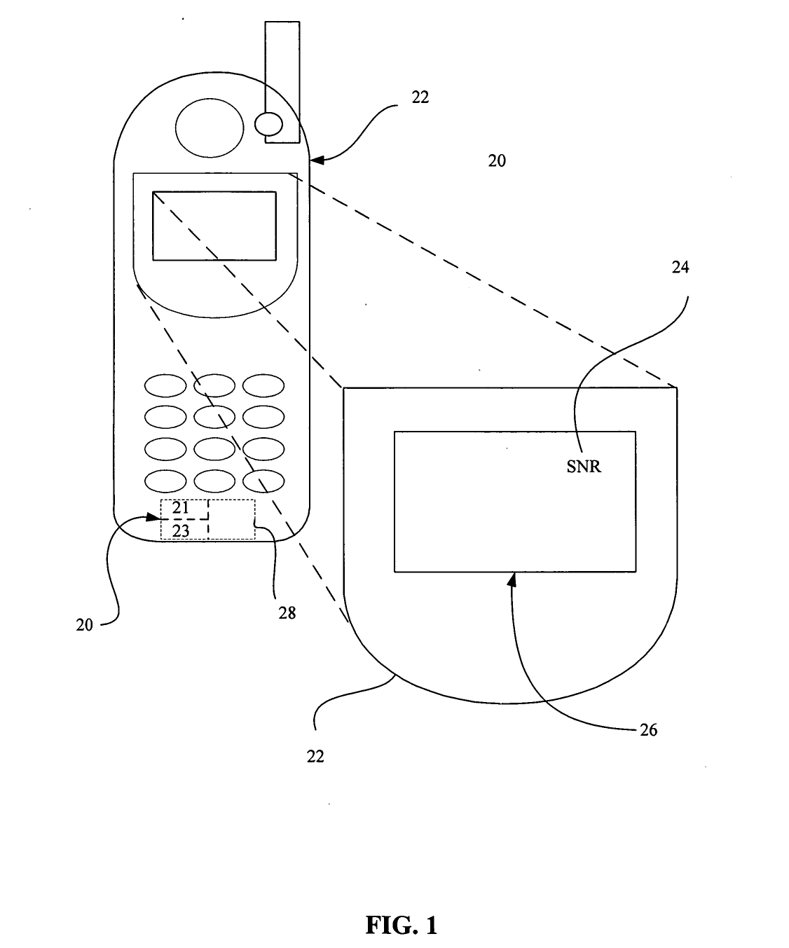

FIG. 1 provides a schematic diagram of an environment in which a system 20 according to the present invention can be used. The system 20 is illustratively contained within a portable phone 22 and provides a cue 24 to a portable phone user. The cue 24, as explained herein, influences an SNR associated with the portable phone user's voice input via the portable phone 22 into a speech recognition device 28 that is illustratively contained within the portable phone. Alternatively, however, the speech recognition device can be remotely located from the portable phone. For example, the speech recognition device 28 alternately can comprise a general-purpose computer or a special-purpose device, either of which can include the requisite circuitry and software for effecting speech recognition.

Illustratively, the cue 24 provided to the user is a visual cue that can be displayed to the user using a visual display 26 included on the face of the portable phone 22. As will be readily appreciated by one of ordinary skill in the art, however, other types of cues can alternately or additionally be provided by the system 20 to the user. For example, the cue can comprise an audible signal rather than a visual one. Such an audible signal can include, for example, a short audible sound with relatively high pitch that the user hears as one or more intermittent “beeps.” Such audible cues can be provided by the system 20 via the audio portion of the portable phone 22. In still another embodiment, the cue can comprise both a visual cue and an audible cue. Other types of cues that can be advantageously used by the system 20 include, for example, tactile-based mechanisms such as one that attracts the portable phone user's attention by causing the phone to gently vibrate.

The visual, audible, or other cue provided by the system 20 indicates whether the SNR associated with the user's voice input into the speech recognition device is at an acceptable level. If it is not, the system 20 indicates such via the cue so that the user can respond accordingly to thereby bring the SNR to an acceptable level or within an acceptable range. For example, the user can respond to the cue provided by the system 20 by increasing the strength of the signal input by speaking more loudly. Alternatively, the user can respond by changing the ambient conditions under which the signal input is being inputted into the device by moving to a quieter location while providing voice input to the speech recognition device.

The SNR is based on an SNR measurement generated by the system 20, as explained in detail below. As explained below, the SNR measurement can comprise more than a conventional SNR measurement. Instead of a conventional SNR measurement, the SNR measurement generated by the system 20 can comprise a comparison of speech content of an input signal to non-speech content of the input signal.

It is to be understood throughout the discussion herein that the illustrated portable phone 22 is only one environment in which the system 20 can be used. For example, the system 20 alternatively can be contained in, or used with, a personal computer or other general purpose computing device having speech recognition capabilities. Alternately, the system 20 can be contained in or used with a special-purpose computing device such as a server having speech recognition capabilities. The system 20 similarly can be contained in or used with various other data processing and/or communication devices having speech recognition capabilities.

Additionally, the system 20 need not locally process speech, but can utilize a communicatively linked network element (not shown) to process the speech and to determine the SNR. The network element can provide an indicator to the local device so that the local device can alert a user when the SNR is low. For example, in one embodiment, the local device can include a telephone and the network element can be a speech recognition engine linked to the telephone via a telephone network. The telephone network can be a circuit-switched network, packet-switched network, wireless network, or any combination of such networks.

In one embodiment, the system 20 can include a user interface (not shown) that permits the user to adjust the parameters of the cue 24. For example, the user of the system 20 can establish an SNR threshold at which the cue 24 is to be presented. The cue 24 might also include a range indicator, as opposed to a warning signal, similar to a battery meter or a signal-strength meter on a mobile telephone.

In still another embodiment, a remote application can be permitted to adjust parameters associated with the cue 24. For example, the user of the system 20 can be communicatively linked to a voice response system. The voice response system can establish SNR thresholds necessary to accurately recognize speech. Since different voice response systems can utilize different techniques and algorithms for performing speech recognition operations and for discerning speech from noise, an acceptable SNR can vary from one voice response system to another.

Moreover, as will be readily apparent to one of ordinary skill in the art from the ensuing discussion, the system 20 can be implemented in one or more sets of software-based processor instructions. Alternatively, the system 20 can be implemented in one or more dedicated circuits containing logic gates, memory, and similar known components, as will also be readily apparent to one of ordinary skill from the following discussion.

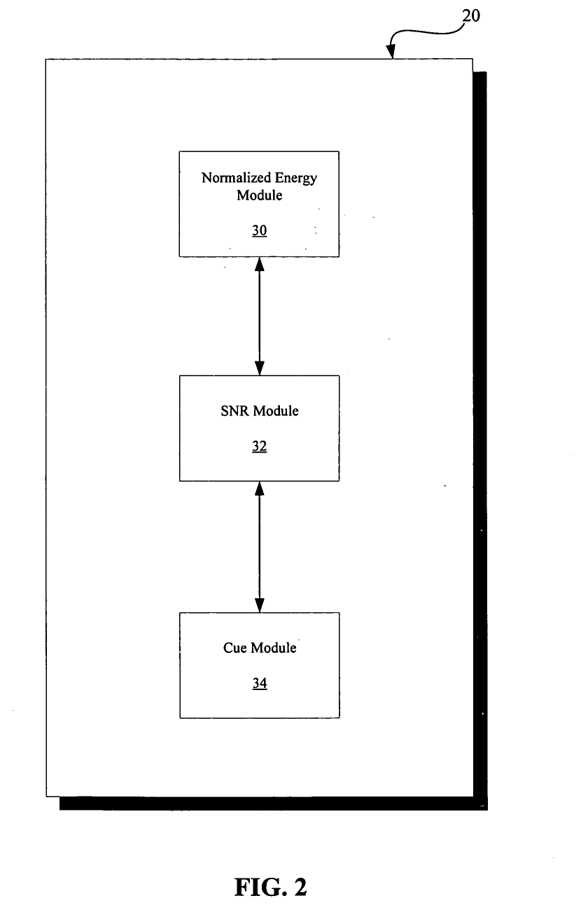

Referring additionally to FIG. 2, the system 20 illustratively includes a an energy module 30. The energy module 30, as explained below, determines an energy measurement that is used by the system 20 in creating an SNR-based cue. As illustrated, the system 20 further includes an SNR module 32. The SNR module 32 generates an SNR measurement based upon the energy measurement. The system 20 also illustratively includes a visual cue module 34 that provides a visual cue via the visual display 26 to a user. The cue 24, as explained below, is based upon the SNR measurement.

Various techniques can be employed by the system 20 for generating the SNR measurement. For example, the SNR can be derived from the autocorrelation of signal and noise, wherein both are assumed have Gaussian distributions. Other techniques can similarly be employed. These techniques can be based upon energy or power measurements associated with an input signal. Moreover, as noted already, the SNR measurement, according to one embodiment, can comprise more than a conventional SNR measurement, and can instead comprise a comparison of the speech content of the input signal to the non-speech content of the signal. As explained below, the comparison of speech content to non-speech content can be based upon a frame-wise comparison of signal energy to a stored profile, or history, of known signals to determine which portions of input signals contain speech and which do not contain speech.

In one embodiment, the SNR measurement of the system 20 is determined using a normalized energy measurement of an arbitrary time-varying signal, x(t). It corresponds to the following time-domain mathematical definition:

$$E = {lim}_{T \to ∞} {\int }_{- T}^{T} {\vert x ( t ) \vert}^{2} ⅆ t = {\int }_{- ∞}^{∞} {\vert x ( t ) \vert}^{2} ⅆ t ,$$

The following, accordingly, is the corresponding frequency-domain definition based on the Fourier transform of the time-domain variable:

$$E = {\int }_{- ∞}^{∞} x * ( t ) [ {\int }_{- ∞}^{∞} X ( f ) {ⅇ}^{j2π f t} ] ⅆ t = {\int }_{- ∞}^{∞} {\vert X ( f ) \vert}^{2} ⅆ f$$

The normalized energy measurement determined by the system 20 thus can be based upon a spectrum of frequency-domain complex coefficients. The system 20 advantageously relies on front-end processing performed by the automatic speech recognition device 28 to generate the spectrum of frequency-domain complex coefficients. Front-end processing is employed in the automatic speech recognition device 28 for transforming a speech-based signal into a sequence of feature vectors. The feature vectors are used as part of a classification scheme for effecting speech recognition, as will be readily understood by one of ordinary skill in the art.

The frequency-domain complex coefficients are generated by the automatic speech recognition device 28 as a by-product of a Mel-frequency cepstrum feature extraction. As also will be readily understood by one of ordinary skill in the art, the Mel-frequency cepstrum feature extraction comprises a conversion based upon a Fast Fourier Transform (FFT) and a subsequent filtering of a real amplitude spectrum using a Mel-frequency filter bank.

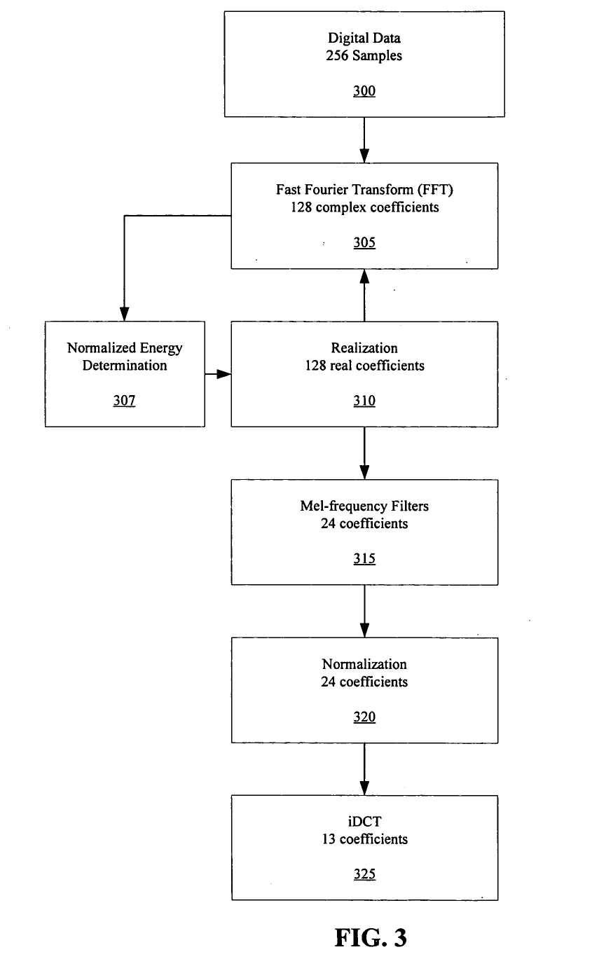

Referring also now to FIG. 3, the salient steps of the Mel-frequency cepstrum feature extraction are as follows. The signal input is sampled to obtain a digital signal representative of the signal input. As will be readily understood by one of ordinary skill in the art, the sampling rate can be designed in accordance with the range of frequencies of the signal input and the capabilities of the particular system in which it is employed. For example, with respect to a telephony-based audio signal, a sampling rate of 8000 Hz can be sufficient if the maximum frequency of the input signal is not likely to exceed 4000 Hz. For a telephone system having a full-range capability, though, the relevant speech band can be up to 8000 Hz. Therefore, in this latter event, the sampling rate should be 16000 Hz.

The digitized signal is fed into the speech recognition device 28, which separates the signal into multiple sample frames at step 300. Typical sizes of these frames range from 10-20 milliseconds or 128-256 samples. To mitigate effects due to discontinuities, the frames are weighted using the Hamming window. As will be readily understood by one of ordinary skill in the art, the Hamming window denotes a well-known signal processing technique that is used, for example, in connection with finite impulse response (FIR) filter design. At step 305, a power spectrum for each frame is determined based upon a Fast Fourier Transform (FFT). The FFT is an efficient computational technique for generating a spectrum of complex-valued coefficients, as will also be readily understood by one of ordinary skill in the art. Using for example a 256 sample size, as illustrated, and computing over a step size or window shift of 50-75 percent, the result is 128 complex-valued coefficients that are mathematically transformed to real-valued coefficients at step 310.

Having obtained the real-valued coefficients, the resulting real-valued amplitude spectrum is passed through a Mel-frequency bank of filters. The Mel-frequency bank of filters is designed to model human differential pitch sensitivity. The number of filters is typically between 13 and 24. Illustratively, the filtering using a 24-filter bank, the process yields 24 coefficients at step 315. The coefficients obtained by filtering with the 24-filter bank are normalized at step 320.

Ultimately, at step 325, 13 cepstra coefficients are determined through an inverse discrete cosine transformation. The inverse discrete cosine transformation converts the 24 normalized Mel-filter coefficients to 13 cepstral-domain coefficients. A known advantage of the inverse discrete cosine transformation step is that it provides an orthogonal transformation that efficiently de-correlates the spectral coefficients. That is, it converts statistically dependent spectral coefficients into independent cepstral coefficients. The first cepstral coefficient describes the overall energy contained in the spectrum. A second cepstral coefficient measures the remainder between the upper and lower halves of the spectrum. Higher order coefficients represent finer gradations of the spectrum.

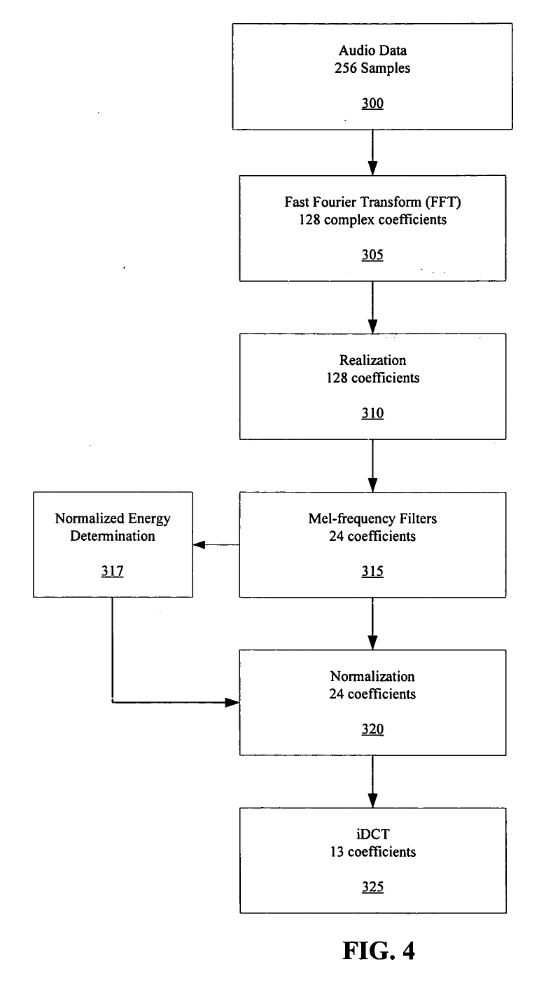

The automatic speech recognition device 28 is representative of the broad class of such devices that typically include front-end signal processing as just described, along with acoustic and language modeling modules. The system 20 advantageously uses the operations described for the front-end processing to determine the normalized energy measurement. More particularly, according to one embodiment, the normalized energy module 30 of the system 20 averages the energy measurements determined from the power spectrum generated for each frame. Illustratively, the averaging is done at step 307, after the FFT is performed at step 305. Alternately, according to another embodiment illustrated in FIG. 4, the averaging is done at step 317, after the FFT and Mel-frequency filtering are performed. The averaging at step 307 provides a relatively more accurate determination of the normalized energy measurement, whereas the averaging at step 317 is relatively more efficient.

According to yet another embodiment, the normalized energy module 30 determines a normalized energy measurement based upon a root-mean-square (RMS) power measurement of an audio signal. The RMS power measurement is illustratively obtained from samples of the audio signal. The samples are segmented into a plurality sample blocks or frames. A block or frame, for example, has a time dimension of 50 milliseconds, or comprises 550 samples for an audio signal at 11025 Hz. Again, since the sampling and framing is typically done as part of the front-end processing performed by the automatic speech recognition device 28, the normalized energy module 30 of the system 20 advantageously utilizes the sample blocks or frames already obtained by the automatic speech recognition device 28. By using data already produced as a by-product of the Mel-frequency cepstrum feature extraction, the system 20 provides an SNR measurement while avoiding the resource cost of computing the measurement directly. This, accordingly, reduces the resource cost that would otherwise be incurred in generating the RMS power measurement determination.

Using the sample frames so obtained, the normalized energy module 30 squares each sample in a frame and averages each squared value to determine a mean value. The square root of the mean is then computed. Since it may be desirable to obtain energy an measurement in terms of power in a logarithmic-scale, the normalized energy module 30 is configured to compute the following:

$$20 * {log}_{10} [ \sqrt{( {\sum }_{i = 1}^{n} {x}_{i}^{2} / n )} ] = 10 * ( {log}_{10} \overline{{x}^{2}} ) .$$

As will be readily appreciated by one of ordinary skill in the art, the normalized energy module 30 can be implemented using one or more software-based processing instructions configured to cooperatively carryout the operations described in conjunction with the feature extraction performed by the automatic speech recognition device 28. Alternatively, as will also be readily appreciated by one of ordinary skill in the art, the normalized energy module 30 can instead be implemented as a dedicated hardwire circuit that cooperatively functions with the automatic speech recognition device 28. Still further, the energy module 30 can implemented through a combination of software-based processing instructions and dedicated hardwire circuitry.

Although the Mel-frequency cepstrum feature extraction can offer computational advantages in carrying out the front-end processing of a speech recognition process, other techniques alternately can be employed. For example, another approach is based upon linear predictive coding (LPC). The LPC technique also is based upon sampling a speech signal, and can alternately be employed by the automatic speech recognition device 28. Accordingly, the calculations used in the LPC can be advantageously utilized by the system 20 in the same manner as described above. Other speech recognition techniques can similarly be employed by the speech recognition device 28 and utilized advantageously by the system.

Based on the normalized energy measurements, determined as described above, the SNR module 32 generates an SNR measurement. The SNR measurement, as already noted, is an oft-used figure of merit that provides an indication of a system's performance. Since the SNR typically measures a ratio of the power or energy of an input signal to the power or energy of noise affecting the system into which the signal is inputted, the SNR generated by the SNR module 32 provides an indication of the relative strength of the speech signal to ambient noise. Since a low SNR adversely affects the speech recognition processes of the automatic speech recognition device 28, including feature extraction and silence detection, it is desirable to provide for SNR improvement in the event of a low SNR.

The framing of input signals and resulting determination of corresponding energy levels enables the comparison of speech to non-speech content, according to one embodiment. More particularly, the SNR module 32 generates a group of samples based on the signal input. A signal history or profile, which can be stored in a memory (not shown), is accessible to the SNR module 32 and comprises at least one frame of speech and at least one frame of non-speech. This enables the SNR module 32 to compare the energy of the signal input, determined as described above, for example, with that of the stored signal profile or history. The comparison enables a determination of whether the signal input contains speech and/or non-speech content, and where each is located within an input signal (i.e., where speech begins and ends versus where non-speech begins and ends). This determination can be made with a reasonable degree of accuracy. Accordingly, the SNR module 32 generates an SNR measurement based on a comparison of the speech content to the non-speech content of the input signal.

According to still another embodiment, the determination made by the system 20 regarding which portions of a signal input contain speech and which portions contain non-speech is based upon a Gaussian distance measurement relative to predetermined silence and speech models. The determination of whether the signal contains speech or not is based on whether a current frame of the signal is closer to the silence model or to the speech model. Again, these determinations enable the SNR module 32 to generate an SNR measurement based on a comparison of the speech content to the non-speech content of the input signal.

With respect to both of these illustrative techniques of determining which portions of signal input contain speech and which contain non-speech, multiple frames can be stored and averaged so as to provide smoother transitions as the signals change and so as to eliminate spikes and valleys in the signal profile. This can provide smoother changes as the SNR transitions from one level to another.

Illustratively, the system 20 employs the visual cue module 34 to provide a cue 24 to a user. The cue 24, as already noted, indicates the SNR corresponding to an on-going speech recognition process. The SNR-based cue 24 is better than traditional volume-related cues, since the latter are directly affected by ambient noise when ambient noise may be one of the dominant factors, or the dominant factor, contributing to a poor speech recognition performance. The cue 24 is displayed so that a user may respond appropriately. For example, if a user is speaking too softly, then the audio signal relative to a noise level may be low. Therefore, the SNR measurement is indicated by the visual cue 24, and the user can respond by speaking more loudly and/or relocating to a less noisy environment.

In accordance with one embodiment, the visual cue module 34 provides a visual cue indicating whether or not the SNR measurement is within a pre-determined acceptable range. The acceptable range can comprise an upper bound and a lower bound, such that a pre-determined acceptable range is within the two bounds. Accordingly, the visual cue module 34 can provide a visual cue indicating that the SNR measurement is not within the acceptable range. Alternately, visual cue module 34 can provide one visual cue indicating that the SNR measurement is less than the lower bound of the acceptable range, and another indicating that the SNR measurement is greater than the upper bound.

The cue 24 provided by the visual cue module 34 illustratively comprises the three letters “SNR.” Illustratively, the letters change color or hue (not shown) depending on whether the SNR measurement is within the acceptable range. For example, if the SNR is not within the acceptable range of measurements, the letters are displayed in red. If the SNR is within the acceptable range, however, the letters “SNR” are instead displayed in green. As will be readily apparent, different color schemes can be used, or instead, a single color having different hues can be used as well. Alternate visual cues can be provided by the visual cue module 34, apart from those provided according to a designated color-based scheme. These alternate visual cues include cues based upon a numbering scheme as well as those based upon a word or lettering scheme. Additionally, the cue 24 can alternately be provided using one or more symbols, such as the international symbol of a circle containing a diagonal line therein and imposed over another symbol such as an ear, a phone, or similar type symbol denoting some connection to a speech-based exchange.

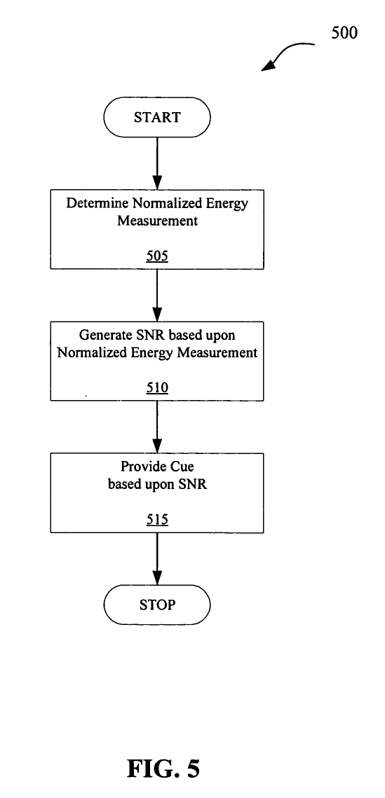

A method aspect according to another embodiment of the present invention is illustrated by the flowchart in FIG. 5. The illustrated method 500 includes, at step 505, determining a normalized energy measurement, wherein the normalized energy measurement is based upon a spectrum of frequency-domain complex coefficients generated by a automatic speech recognition device. The method includes generating, an SNR measurement based upon the normalized energy measurement at step 510. At step 515, the method includes providing a cue to a user of the automatic speech recognition, the cue being based upon the SNR measurement. The cue can be a visual cue. Alternately, the cue can be an audible cue.

As described above in the context of the system 20, the spectrum of frequency-domain complex coefficients are generated as a by-product of a Mel-frequency. cepstrum feature extraction comprising a Fast Fourier Transform (FFT) calculation and a subsequent filtering of a real amplitude spectrum using a Mel-frequency filter bank.

Accordingly, the determining of a normalized energy measurement at step 505 can be performed after the FFT calculation is performed and prior to the subsequent filtering. Alternatively, the determining of a normalized energy measurement at step 505 can performed after the FFT calculation is performed and after the subsequent filtering. Moreover, the SNR can be based upon a root-mean-square (RMS) power measurement, as also described in detail in the context of the system 20. According to still another embodiment, the SNR can be based upon a comparison of the speech content to the non-speech content of the signal input, as also described in detail above. The comparison, moreover, can be made prior to or after signal processing according to the steps described.

As also described above, the visual cue based upon the SNR measurement indicates whether or not the SNR measurement is within a pre-determined acceptable range. The acceptable range, again, can comprise an upper and a lower bound, in which event, the providing of a visual cue at step 515 encompasses providing a visual cue indicating that the SNR measurement is less than the lower bound and/or the SNR measurement is greater than the upper bound.

The present invention can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. A system for influencing a signal-to-noise ratio (SNR) associated with signal inputs to an automatic speech recognition device, the system comprising:
an SNR module that generates an SNR measurement associated with a signal input supplied by a user to the automatic speech recognition device; and
a cue module that provides a cue to the user based upon the SNR measurement.

2. The system of claim 1, wherein the SNR measurement generated by the SNR module is based upon a comparison of speech content of the signal input to non-speech content of the signal input.

3. The system of claim 1, further comprising a normalized energy module that determines a normalized energy measurement based upon a power spectrum of frequency-domain complex coefficients generated by the automatic speech recognition device; and wherein the SNR measurement is based upon the normalized energy measurement

4. The system of claim 3, wherein the spectrum of frequency-domain complex coefficients are generated as a by-product of a Mel-frequency cepstrum feature extraction comprising a Fast Fourier Transform (FFT) calculation and a subsequent filtering of a real amplitude spectrum using a Mel-frequency filter bank.

5. The system of claim 4, wherein the normalized energy module determines the normalized energy measurement after the FFT calculation is performed and prior to the subsequent filtering.

6. The system of claim 4, wherein the normalized energy module determines the normalized energy measurement after the FFT calculation is performed and after the subsequent filtering.

7. The system of claim 1, wherein the cue module provides a visual cue indicating whether or not the SNR measurement is within a pre-determined acceptable range.

8. The system of claim 7, wherein the acceptable range comprises an upper and a lower bound, and wherein the cue module provides a visual cue indicating at least one of the SNR measurement being less than the lower bound and the SNR measurement being greater than the upper bound.

9. A method of influencing a signal-to-noise ratio (SNR) associated with signal inputs to an automatic speech recognition device, the method comprising
generating an SNR measurement associated with a signal input supplied by a user to the automatic speech recognition device; and
providing a cue to the user based upon the SNR measurement.

10. The method of claim 9 wherein the SNR measurement generated is based upon a comparison of speech content of the signal input to non-speech content of the signal input.

11. The method of claim 9, further comprising determining a normalized energy measurement based upon a spectrum of frequency-domain complex coefficients generated by the automatic speech recognition device.

12. The method of claim 11, wherein the spectrum of frequency-domain complex coefficients are generated as a by-product of a Mel-frequency cepstrum feature extraction comprising a Fast Fourier Transform (FFT) calculation and a subsequent filtering of a real amplitude spectrum using a Mel-frequency filter bank.

13. The method of claim 12, wherein determining is performed after the FFT calculation is performed and prior to the subsequent filtering.

14. The method of claim 12, wherein determining is performed after the FFT calculation is performed and after the subsequent filtering.

15. The method of claim 9, wherein providing comprises providing a visual cue indicating whether or not the SNR measurement is within a pre-determined acceptable range.

16. The method of claim 15, wherein the acceptable range comprises an upper and a lower bound, and wherein providing a visual cue comprises providing a visual cue indicating at least one of the SNR measurement being less than the lower bound and the SNR measurement being greater than the upper bound.

17. A computer-readable storage medium for use with an automatic speech recognition (ASR) device to influence an SNR associated with an input to the ASR device, the storage medium comprising computer instructions for:
generating an SNR measurement associated with a signal input supplied by a user to the automatic speech recognition device; and
providing a cue to a user of the automatic speech recognition, the cue being based upon the SNR measurement.

18. The computer-readable storage medium of claim 17, wherein the SNR measurement generated is based upon a comparison of speech content of the signal input to non-speech content of the signal input.

19. The computer-readable storage medium of claim 17, wherein the storage medium further comprises a computer instruction for determining a normalized energy measurement based upon a spectrum of frequency-domain complex coefficients generated by the automatic speech recognition device.

20. The computer-readable storage medium of claim 19, wherein the spectrum of frequency-domain complex coefficients are generated as a by-product of a Mel-frequency cepstrum feature extraction comprising a Fast Fourier Transform (FFT) calculation and a subsequent filtering of a real amplitude spectrum using a Mel-frequency filter bank.
